(19) United States
(12) Patent Application Publication
(10) Pub. No.: US 2014/0259030 A1
(43) Pub. Date: Sep. 11, 2014

(54) MOBILE INFORMATION DEVICE

(71) Applicants: Takehisa Mizuguchi, Tokyo (JP); Yoshiaki Watanabe, Tokyo (JP); Yasuaki Takimoto, Tokyo (JP); Takeshi Mitsui, Tokyo (JP); Yoshihiro Nakai, Hyogo (JP)

(72) Inventors: Takehisa Mizuguchi, Tokyo (JP); Yoshiaki Watanabe, Tokyo (JP); Yasuaki Takimoto, Tokyo (JP); Takeshi Mitsui, Tokyo (JP); Yoshihiro Nakai, Hyogo (JP)

(73) Assignee: MITSUBISHI ELECTRIC CORPORATION, Tokyo (JP)

(21) Appl. No.: 14/350,325

(22) PCT Filed: Jan. 25, 2012
(86) PCT No.: PCT/JP2012/000459

§ 371 Date: Apr. 7, 2014

(51) Int. Cl. G06F 9/54

(52) U.S. Cl. CPC G06F 9/542
USPC 719/328

(57) ABSTRACT

A mobile information device includes a general-UI API 32 that generates screen data about a screen layout specified by an application 2, a UI-during-travel API 33 that generates screen data about a screen layout used during travel which is specified by the application 2 and is to be displayed when a vehicle is travelling on the basis of template data defining a screen layout used during travel which is to be displayed when the vehicle is travelling, and a controller 31 that is disposed in an application execution environment 3, and that causes a display unit 5 to display the screen data generated by the general-UI API 32 when the vehicle is at rest and causes the display unit 5 to display the screen data generated by the UI-during-travel API 33 when the vehicle is travelling.

### FIELD OF THE INVENTION

The present invention relates to a mobile information device mounted in a moving object, such as a vehicle, and equipped with a display for displaying an application image.

### BACKGROUND OF THE INVENTION

An information device mounted in a vehicle or the like needs to limit a screen display and the driver's operation based on this screen display when the vehicle is travelling in such a way as not to prevent the driver from driving the vehicle. For example, nonpatent reference 1 describes that the amount of information which an information device for vehicle displays on the screen should be optimized so that the driver can check the on-screen information in a short time.

Further, patent reference 1 discloses a vehicle-mounted device equipped with a contact-type input unit, such as a touch panel, for carrying out an input operation on the basis of a screen display, and a portable input unit, such as a dial switch, for carrying out a selection operation by moving a focus on the screen. This device displays a menu screen consisting of a column of menu items suitable for input using the touch panel on a display unit when the vehicle is at rest, and displays a menu screen consisting of a column of menu items suitable for input using the dial switch on the display unit when the vehicle is travelling. The vehicle-mounted device disclosed by the patent reference 1 thus prepares both the menu screen suitable for display when the vehicle is at rest and the menu screen suitable for display when the vehicle is travelling in advance, and switches between the menu screens according to the state of the vehicle, thereby improving the ease of use of the selection of a menu item.

On the other hand, there is an increasingly demand to download and use applications (referred to as third party applications from here on), which are developed by third parties other than the manufacture makers of vehicle-mounted information devices, in the vehicle-mounted information devices as the communication functions and the information processing abilities of the vehicle-mounted information devices have become more sophisticated in recent years. Also in this case, it is necessary for the manufacture makers of vehicle-mounted information devices to force third party applications to comply with limitations imposed on operations when the vehicle is travelling.

### RELATED ART DOCUMENT

### Patent Reference

Patent reference 1: Japanese Unexamined Patent Application Publication No. 2008-65519

### Nonpatent Reference

Nonpatent reference 1: “Guidelines for In-vehicle Display Systems Version 3.0”, Japan Automobile Manufacturers Association, Inc., August 18, Heisei 16 (2004)

### SUMMARY OF THE INVENTION

### Problems to be Solved by the Invention

A UI (User Interface), such as a screen display or acceptance of an operation, for use in a third party application is developed using APIs (Application Program Interfaces) which are provided by a vehicle-mounted information device. By using APIs, display elements including character strings, images, and buttons and constructing a screen can be specified, and, in general, display elements can be placed freely and their sizes can also be specified. Therefore, in a case in which a third party application is not designed for vehicle-mounted devices, the third party application can display a character string, an image, a button, etc. on the screen freely regardless of whether the vehicle is at rest or travelling.

On the other hand, in order to verify whether a third party application complies with limitations imposed on operations when the vehicle is travelling, it is necessary to examine and check all the operations of the third party application on the vehicle-mounted information device. Therefore, it is very difficult for the manufacture maker of the vehicle-mounted information device to carry out the verification on all third party applications.

To solve this problem, if a measure is taken to prohibit the operations of any third party application when the vehicle is travelling, the verification work done by the manufacture maker of the vehicle-mounted information device can be eliminated. However, there is a case in which the driver wants to browse a small amount of information or carry out a simple operation in a manner which doesn't interfere with his or her driving even when driving the vehicle, and the one-size-fits-all prohibition of operations when the vehicle is travelling impairs the user's convenience remarkably.

Further, because the conventional technology represented by the patent reference 1 is based on the premise that both a menu screen suitable for display when the vehicle is at rest and a menu screen suitable for display when the vehicle is travelling are prepared in advance, it is impossible to apply this premise to third party applications which are developed by manufacture makers other than the manufacture maker of the vehicle-mounted information device, just as it is. The conventional technology disclosed by the patent reference 1 is further premised on an application installed at the time of manufacturing the vehicle-mounted device, and does not even provide an idea of changing a screen display and operation information provided by a third party application to a screen and operation information suitable for display when the vehicle is travelling.

The present invention is made in order to solve the above-mentioned problems, and it is therefore an object of the present invention to provide a mobile information device that can display a screen suitable for display when a moving object is travelling.

### Means for Solving the Problem

A mobile information device in accordance with the present invention includes: a first API that generates screen data about a screen layout specified by an application; a second API that generates screen data about a screen layout specified by the application and used during travel on the basis of template data defining a screen layout used during travel which is to be displayed when a moving object is travelling; and a controller that is disposed in an application execution environment, and that causes a display to display the screen data generated by the first API when the moving object is at rest and causes the display to display the screen data generated by the second API when the moving object is travelling.

### Advantages of the Invention

According to the present invention, there is provided an advantage of being able to display a screen suitable for display when a moving object is travelling.

### BRIEF DESCRIPTION OF THE FIGURES

FIG. 1 is a block diagram showing the structure of a mobile information device in accordance with Embodiment 1 of the present invention;

FIG. 2 is a diagram showing an example of screen data in which a screen layout displayed when a vehicle is at rest is expressed in an HTML (Hyper Text Markup Language) form;

FIG. 3 is a diagram showing a screen displayed on the basis of the screen data shown in FIG. 2;

FIG. 4 is a diagram showing an example of screen data in which a screen layout displayed when the vehicle is travelling is expressed in an XML (eXtensible Markup Language) form;

FIG. 5 is a diagram showing a screen displayed on the basis of the screen data shown in FIG. 4;

FIG. 6 is a diagram showing an example of screen data in which a screen layout displayed when the vehicle is travelling is expressed in an XML form;

FIG. 7 is a diagram showing a screen displayed on the basis of the screen data shown in FIG. 6;

FIG. 8 is a flow chart showing the operation of the mobile information device in accordance with Embodiment 1;

FIG. 9 is a flowchart showing the operation of a mobile information device in accordance with Embodiment 2 of the present invention;

FIG. 10 is a flow chart showing the operation of a mobile information device in accordance with Embodiment 3 of the present invention;

FIG. 11 is a diagram showing an example of a display screen displayed when the vehicle is travelling in Embodiment 3;

FIG. 12 is a block diagram showing the structure of a mobile information device in accordance with Embodiment 4 of the present invention;

FIG. 13 is a flow chart showing the operation of the mobile information device in accordance with Embodiment 4;

FIG. 14 is a diagram showing an example of screen data in which a screen layout displayed when the vehicle is travelling is expressed in an XML form;

FIG. 15 is a diagram showing an example of screen data in which a screen layout displayed when the vehicle is travelling is expressed in an HTML form;

FIG. 16 is a diagram showing a screen displayed on the basis of the screen data shown in FIG. 15;

FIG. 17 is a diagram showing another example of screen data in which a screen layout displayed when the vehicle is travelling is expressed in an XML form;

FIG. 18 is a diagram showing a screen displayed on the basis of the screen data shown in FIG. 17;

FIG. 19 is a diagram showing another example of screen data in which a screen layout displayed when the vehicle is travelling is expressed in an HTML form;

FIG. 20 is a block diagram showing the structure of a mobile information device in accordance with Embodiment 5 of the present invention;

FIG. 21 is a flow chart showing the operation of the mobile information device in accordance with Embodiment 5;

FIG. 22 is a diagram showing an example of screen data in which a screen layout displayed when the vehicle is travelling is expressed in an XML form.

### EMBODIMENTS OF THE INVENTION

Hereafter, in order to explain this invention in greater detail, the preferred embodiments of the present invention will be described with reference to the accompanying drawings.

### Embodiment 1

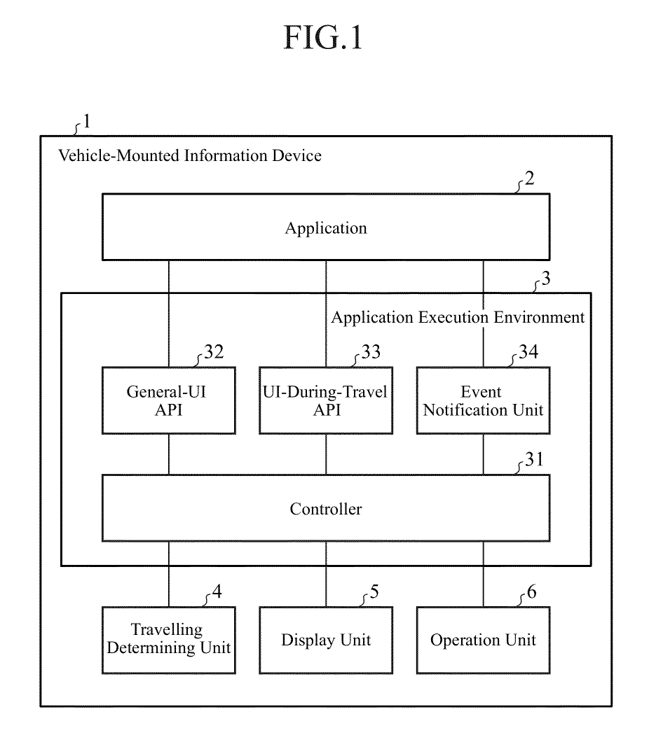

FIG. 1 is a block diagram showing the structure of a mobile information device in accordance with Embodiment 1 of the present invention, and shows a case in which the mobile information device in accordance with Embodiment 1 is applied to a vehicle-mounted information device. In the vehicle-mounted information device 1 shown in FIG. 1, an application execution environment 3 in which an application 2 is executed, a travelling determining unit 4, a display unit 5, and an operation unit 6 are disposed. The application 2 is software that is operated by the application execution environment 3, and can be software that carries out a process according to one of various objects and applications, such as software that monitors and controls the vehicle-mounted information device 1, software that carries out navigation processing, or software that carries out a game. The program of the application 2 can be pre-stored in the vehicle-mounted information device 1 (a storage unit not shown in FIG. 1), can be downloaded from outside the vehicle-mounted information device via a network, or can be installed from an external storage such as a USB (Universal Serial Bus) memory.

The application execution environment 3 causes the application 2 to operate, and includes a controller 31, a general-UI API 32, a UI-during-travel API 33, and an event notification unit 34 as functions thereof. The controller 31 controls an entire operation of causing the application 2 to operate. The controller 31 also has a function of drawing a general screen from screen data about a screen layout (referred to as a general screen layout from here on) which is displayed when a vehicle equipped with the vehicle-mounted information device 1 is at rest, and a function of drawing a screen used during a travel from screen data about a screen layout (referred to as a screen layout used during a travel from here on) which is displayed when the vehicle is travelling.

The general-UI API 32 is an API for enabling the application 2 to specify a general screen layout. This general-UI API 32 is provided for the application 2 when a screen display is produced through a process by the application 2, and generates screen data about a general screen layout specified by the application 2. The UI-during-travel API 33 is an API for enabling the application 2 to specify a screen layout used during a travel. This UI-during-travel API 33 is provided for the application 2 when a screen display is produced through a process by the application 2, and generates screen data about a screen layout used during a travel specified by the application 2. A restriction is imposed on the specification of a screen layout enabled by the UI-during-travel API 33, compared with the specification a screen layout enabled by the general-UI API 32, and the UI-during-travel API 33 enables a specification of only a screen layout suitable for display when the vehicle is travelling. The event notification unit 34 also notifies an event, such as a change in the travelling state of the vehicle or a user operation event using the operation unit 6, to the application 2.

The travelling determining unit 4 connects to a speed sensor etc. which are mounted in the vehicle and determines whether the vehicle is travelling or at rest, and notifies the determination result to the application execution environment 3 as a travelling state change event. The display unit 5 is a display device, such as a liquid crystal display, that produces a screen display. The display unit 5 displays drawing data about a screen which the controller 31 acquires by carrying out a drawing process on the screen thereof. The operation unit 6 accepts an operation performed by a user, and is implemented by, for example, a touch panel or hardware keys placed on the screen of the display unit 5, or software keys displayed on the screen.

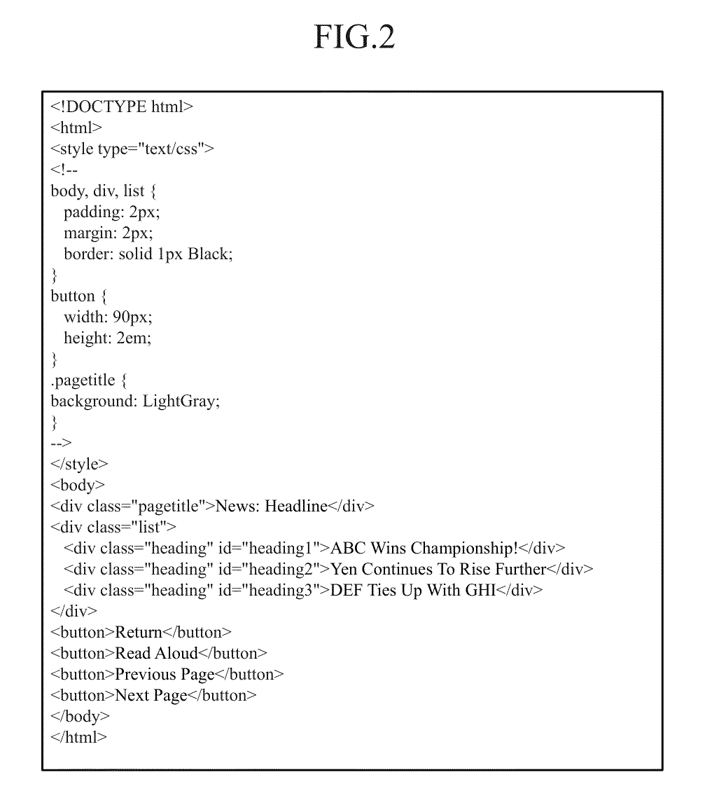

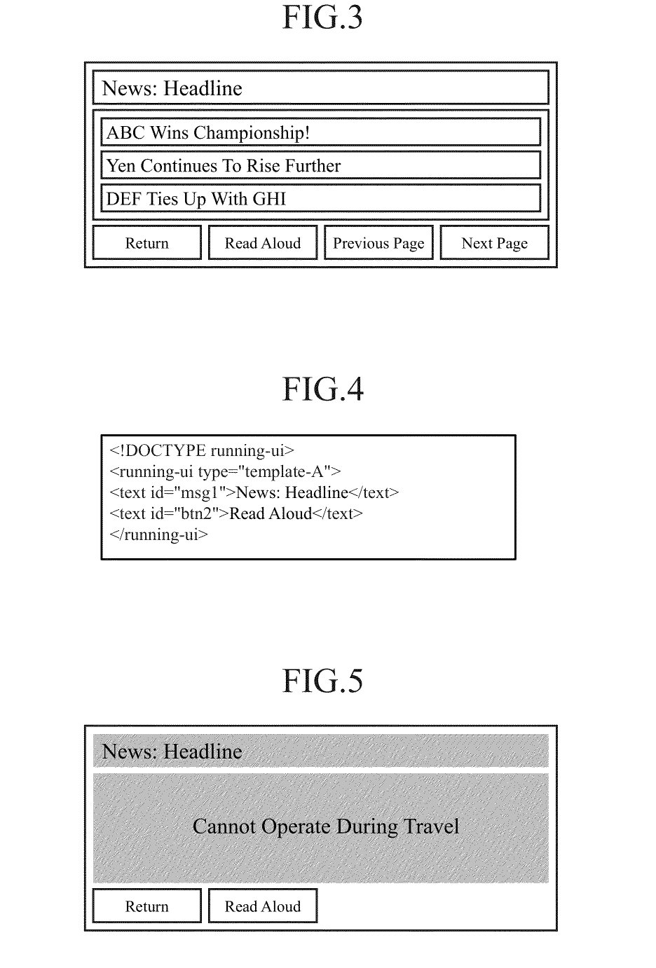

FIG. 2 is a diagram showing an example of screen data about a screen layout (general screen layout) displayed when the vehicle is at rest, the screen data being expressed in an HTML form, and the screen data is specified by using the general-UI API 32. Further, FIG. 3 is a diagram showing a screen displayed on the basis of the screen data shown in FIG. 2. In the example shown in FIG. 2, five <div> elements each for drawing a rectangle in the screen and four <button> elements are described. Further, the style of each of these elements is specified by style specifications of padding, margin, border, width, height, background, etc. which are described in a CSS (Cascading Style Sheet) form in a <style> element. The application 2 determines the arrangement of each of display elements (character strings, images, buttons, etc.) which construct the general screen, and the size of each of the display elements, a font, a font size, the number of characters, etc. according to the descriptions of an operation event, and specifies a general screen layout as shown in FIG. 2 for the general-UI API 32. The general-UI API 32 generates screen data expressed in an internal data form for handling the general screen layout in the application execution environment 3 according to the specification made by the application 2. This internal data form can be an arbitrary one for holding the screen data in such a way that the application execution environment 3 can easily process the screen data. An example of this internal data form is DOM (http://Document Object Model and www.w3.org/DOM/) which is known as a form for enabling computer programs to process HTML data and XML data. In the DOM, HTML data and XML data are simply converted into data in a data form which can be easily handled by computer programs. Therefore, a subsequent explanation of screen data will be made by assuming that the screen data has an HTML or XML format. This screen data is sent from the general-UI API 32 to the controller 31 of the application execution environment 3. The controller 31 analyzes the screen data received from the general-UI API 32, and carries out a drawing process of drawing a general screen according to a drawing command based on the result of this analysis. The display unit 5 receives drawing data generated by the controller 31 and displays a screen as shown in FIG. 3.

FIG. 4 is a diagram showing an example of screen data about a screen layout (screen layout used during a travel) displayed when the vehicle is travelling, the screen data being expressed in an XML form, and the screen data is specified by using the UI-during-travel API 33. Further, FIG. 5 is a diagram showing a screen displayed on the basis of the screen data shown in FIG. 4. The example shown in FIG. 4 is screen data about a screen used during a travel which corresponds to the general screen shown in FIG. 3, and producing a screen display according to the descriptions of “template-A” is shown in the figure. In this example, “template-A” is a screen layout prepared in advance in the UI-during-travel API 33, and a page header (“News: Headline” is displayed in FIG. 5), a message character string of “Cannot display during travel”, and two buttons are displayed. Further, in this example shown in FIG. 4, according to a command from the application 2, the UI-during-travel API 33 replaces the character string of a page header defined by “msg1” with “News: Headline” according to a <text> element, and also replaces the character string of a button defined by “btn2” with “Read Aloud.”

Template data defining a screen layout used during a travel is prepared in advance in the application execution environment 3. The application 2 determines display elements constructing a screen used during a travel according to the descriptions of an operation event, and specifies the display elements for the UI-during-travel API 33. The UI-during-travel API 33 selects the template data (“template-A”) about the above-mentioned screen used during a travel, and generates screen data from the screen layout used during a travel as shown in FIG. 4 on the basis of the display elements specified by the application 2. This screen data is sent from the UI-during-travel API 33 to the controller 31 of the application execution environment 3. The controller 31 analyzes the screen data received from the UI-during-travel API 33, and carries out a drawing process of drawing the screen used during a travel according to a drawing command based of the result of this analysis. The display unit 5 receives drawing data generated by the controller 31 and displays a screen as shown in FIG. 5.

In the example shown in FIG. 5, “ABC Wins Championship!”, “Yen Continues to Rise Further”, and “DEF Ties up with GHI” are omitted from the display elements displayed in the general screen shown in FIG. 3, and the buttons “Previous Page” and “Next Page” are omitted. However, instead of disabling the driver to perform a menu operation at any time when driving the vehicle, like in the case of conventional mobile information devices, the mobile information device in accordance with the present invention maintains display elements corresponding to menu operations having a low possibility of causing the driver to distract his or her attention from his or her driving, such as a menu operation which the driver can complete by performing a single operation. For example, a button “Return” for causing the mobile information device to make a screen transition to the previous screen and a button “Read Aloud” for causing the mobile information device to read the information aloud are displayed in the example of FIG. 5.

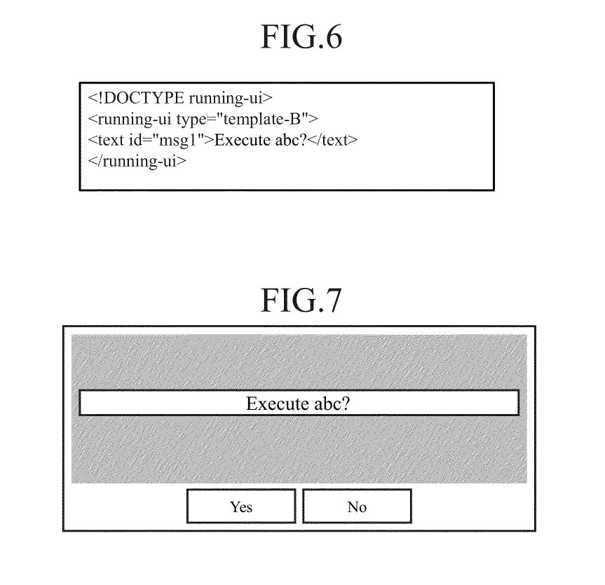

FIG. 6 is a diagram showing another example of the screen data about a screen layout (screen layout used during a travel) displayed when the vehicle is travelling, the screen data being expressed in an XML form, and the screen data is specified by using the UI-during-travel API 33. Further, FIG. 7 is a diagram showing a screen displayed on the basis of the screen data shown in FIG. 6. The example shown in FIG. 6 is screen data about a screen used during a travel which corresponds to the general screen shown in FIG. 3, and producing a screen display according to “template-B” is shown in the figure. In this example, “template-B” is a screen layout prepared in advance in the UI-during-travel API 33, and a character string shown by an identifier “msg1” and buttons “Yes” and “No” are displayed in the screen. Further, in the example shown in this FIG. 6, according to a command from the application 2, the UI-during-travel API 33 replaces the character string of a page header defined by “msg1” with a character string “Execute abc?” according to a <text> element.

In this case, the UI-during-travel API 33 selects the template data (“template-B”) about the screen used during a travel, and generates screen data from the screen layout used during a travel as shown in FIG. 6, the screen layout being expressed in an XML form, on the basis of the display elements specified by the application 2. This screen data is sent from the UI-during-travel API 33 to the controller 31 of the application execution environment 3. The controller 31 analyzes the screen data received from the UI-during-travel API 33, and carries out a drawing process of drawing the screen used during a travel according to a drawing command based of the result of this analysis. The display unit 5 receives drawing data generated by the controller 31 and displays a screen as shown in FIG. 7.

As mentioned above, in order to construct the screen data as shown in FIGS. 4 and 6, the template data defining a screen layout suitable for display when the vehicle is travelling regardless of the application 2 is prepared in the UI-during-travel API 33. When executing the application 2 to produce a screen display corresponding to an operation event, the UI-during-travel API 33 can generate screen data about a screen used during a travel which is suitable for display when the vehicle is travelling by simply applying some of display elements (character strings, images, buttons, etc.) constructing the screen to this template, replacing some of the display elements with simple characters or a simple character string (e.g., “Execute abc?) prepared in advance for the data, or replacing some of the display elements with a display element corresponding to a simple menu operation (e.g., “Read Aloud”) prepared in advance for the data. In accordance with the present invention, a screen suitable for display when the vehicle is travelling is, for example, a one in which information to be displayed including display elements regarding menu operations is omitted or changed in such a way to prevent the driver from distracting his or her attention from his or her driving.

Further, because the above-mentioned template data defines a screen layout which is constructed independently of the application 2, the arrangement of each of character strings, images, buttons, etc., which are the display elements constructing the screen, the size of each of the display elements, the font, the font size, the number of characters, etc. cannot be changed in principle. However, instead of fixing these settings completely, on the condition that a variable range which makes it possible to prevent the driver from distracting his or her attention from his or her driving is defined as a predetermined limit, the aspect of each of the display elements can be changed. For example, in a case in which the font size suitable for display when the vehicle is travelling is set to be 20 points or more, when generating screen data from the template data about a screen used during a travel according to a command from the application 2, the UI-during-travel API 33 changes the font size with a lower limit on the font size being set to this setting of 20 points.

In addition, a plurality of template data defining a plurality of screen layouts which are suitable for display when the vehicle is travelling respectively can be prepared in advance in the application execution environment 3, and the UI-during-travel API 33 is enabled to select one template data from these template data according to a specification made by the application 2. Even in the case in which the mobile information device is constructed this way, because the screen layout used during a travel defined by each template data cannot be changed by the application 2, a screen layout specified by the application 2 is a one (screen used during a travel) surely suitable for display when the vehicle is travelling. Further, there is provided an advantage of enabling even the developer of the application 2 to easily specify a screen used during a travel by using template data.

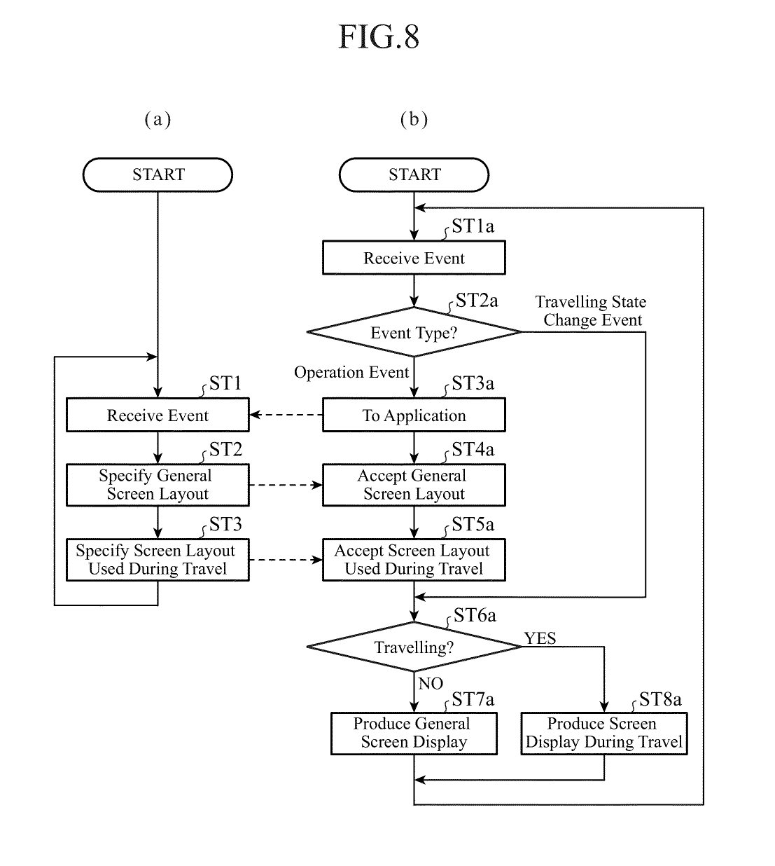

Next, the operation of the mobile information device will be explained. FIG. 8 is a flow chart showing the operation of the mobile information device in accordance with Embodiment 1, and shows the details of a screen display according to whether the vehicle is in a rest state or a travelling state. FIG. 8(a) shows a process resulting from the execution of the application 2, and FIG. 8(b) shows a process in the application execution environment 3.

In the application execution environment 3, when receiving an event (step ST1a), the controller 31 determines the type of the event received (step ST2a). In this embodiment, it is assumed that the type of the event is a travelling state change event from the travelling determining unit 4 or an operation event from the operation unit 6. A travelling state change event shows a change in the travelling state of the vehicle, and shows that the vehicle travelling has stopped and is at rest or that the vehicle which has been at rest starts travelling. An operation event shows an operation, such as a touch of a button displayed on the screen of the display unit 5, or a key pushdown. In this embodiment, it is assumed that an operation event shows an operation of causing the application 2 to produce a screen display.

When the type of the received event is a “travelling state change event” (when a travelling state change event occurs in step ST2a), the controller 31 shifts to a process of step ST6a. In contrast, when the type of the event is an “operation event” (when an operation event occurs in step ST2a), the controller 31 notifies the operation event to the application 2 currently being executed in the application execution environment 3 via the event notification unit 34 (step ST3a).

When the event is notified thereto from the application execution environment 3 (step ST1), the application 2 specifies a general screen layout according to this event (step ST2). More specifically, when the event is notified, the application 2 calls the general-UI API 32 to specify display elements constructing a general screen according to the descriptions of the event, and the contents to be displayed of the display elements. The general-UI API 32 generates screen data about the general screen specified by the application 2 (for example, refer to FIG. 2), and sends the screen data to the controller of the application execution environment 3. In the generation of the general screen, the arrangement and the size of each of character strings, images, buttons, etc. which construct the screen, and the font and the font size can be changed as needed.

The application 2 then specifies a screen layout used during a travel according to the event notified thereto from the application execution environment 3 (step ST3). More specifically, the application 2 calls the UI-during-travel API 33 to specify display elements constructing a screen used during a travel according to the descriptions of the event, and the contents to be displayed of the display elements. The UI-during-travel API 33 generates screen data (for example, refer to FIGS. 5 and 7) about the screen used during a travel on the basis of both the template data defining a screen layout used during a travel and the descriptions specified by the application 2, and sends the screen data to the controller 31 of the application execution environment 3. Because when screen data is generated by the general-UI API 32, the UI-during-travel API 33 thus generates screen data about a screen layout used during a travel, the screen data corresponding to the above-mentioned screen data, the mobile information device can switch from the general screen to the screen used during a travel promptly when, for example, the vehicle makes a transition from a rest state to a travelling state. When completing the process of step ST3, the UI-during-travel API 33 returns to step ST1 and repeats the processes in steps ST1 to ST3 every time when receiving an event.

The controller 31 accepts the general screen layout (step ST4a) and then accepts the screen layout used during a travel (step ST5a). More specifically, the controller 31 receives the screen data about the general screen from the general-UI API 32, and then receives the screen data about the screen used during a travel from the UI-during-travel API 33. After that, the controller 31 determines whether or not the vehicle is travelling (step ST6a). The controller carries out this determination by referring to the result of determination of whether or not the vehicle is travelling by the travelling determining unit 4. Also when receiving a travelling state change event from the travelling determining unit 4, the controller carries out this process.

When the vehicle is at rest (when NO in step ST6a), the controller 31 analyzes the screen data about the general screen and carries out a drawing process of drawing the general screen according to a drawing command based on the result of this analysis. The display unit 5 receives drawing data generated by the controller 31, and displays the general screen (step ST7a). In contrast, when the vehicle is travelling (when YES in step ST6a), the controller 31 analyzes the screen data about the screen used during a travel and carries out a drawing process of drawing the screen used during a travel according to a drawing command based on the result of this analysis. The display unit 5 receives drawing data generated by the controller 31, and displays the screen used during a travel (step ST8a). After that, the application execution environment 3 repeats the above-mentioned processes.

As mentioned above, in accordance with this Embodiment 1, the mobile information device includes the general-UI API 32 that generates screen data about a screen layout specified by the application 2, the UI-during-travel API 33 that generates screen data about a screen layout used during a travel which is specified by the application 2 and which is to be displayed when the vehicle is travelling on the basis of template data defining a screen layout used during a travel which is to be displayed when the vehicle is travelling, and the controller 31 that is disposed in the application execution environment 3 and that causes the display unit 5 to display the screen data generated by the general-UI API 32 when the vehicle is at rest and causes the display unit 5 to display the screen data generated by the UI-during-travel API 33 when the vehicle is travelling. Because the mobile information device is constructed this way, the mobile information device can display a screen suitable for display when the vehicle is travelling regardless of the operation of the application 2.

Further, because the mobile information device displays only a screen suitable for display during a travel when the vehicle is travelling even if the application 2 is developed by a third party other than vehicle-mounted information equipment manufacturers, the vehicle-mounted information equipment manufacturers do not have to check whether or not an unsuitable screen is displayed during a travel.

Conventionally, when it is unknown whether or not a screen displayed when executing an application developed by a third party is suitable for display when the vehicle is travelling, by taking into consideration an effort to check whether the screen is suitable, the screen is switched to a non-display state and any menu operation is disabled when the vehicle is travelling. In contrast, according to above-mentioned Embodiment 1, only a screen suitable during a travel as shown in FIGS. 5 and 7 can be displayed.

Further, by including display elements for a simple menu operation in the template data, the driver is enabled to perform a menu operation within the limit which make it possible to prevent the driver from distracting his or her attention from his or her driving also when a screen used during a travel is displayed, and the user's convenience can be improved.

In addition, even the developer of the application 2 can easily construct a screen suitable during a travel for the application 2 or for each process which is carried out by the application 2 by using a screen layout used during a travel and defined in the UI-during-travel API 33.

Further, in accordance with this Embodiment 1, the application execution environment 3 has a plurality of template data defining a plurality of screen layouts used during a travel respectively, and the UI-during-travel API 33 generates screen data about a screen layout used during a travel on the basis of one template data which the UI-during-travel API selects from among the plurality of template data according to a specification made by the application 2. Therefore, screen data suitable for display when the vehicle is travelling can be constructed easily.

In addition, in accordance with this Embodiment 1, the UI-during-travel API 33 changes the display elements constructing the screen layout defined by the template data according to a command from the application 2, and generates screen data about a screen layout used during a travel. For example, the UI-during-travel API replaces a character string in the template data defining a screen layout used during a travel with a character string specified by the application 2 to generate screen data about a screen used during a travel. By doing this way, the mobile information device can construct a screen used during a travel according to the application 2. Even when replacing a character string in the template data with a simple image or the like other than characters and a character string, the mobile information device can provide the same advantage.

In addition, in accordance with this Embodiment 1, the UI-during-travel API 33 changes the aspect of each of display elements constructing a screen used during a travel generated on the basis of the template data within the predetermined limit according to a command from the application 2. For example, the UI-during-travel API is enabled change the aspect of each of the display elements within the predetermined limit defining a range which makes it possible to prevent the driver from distracting his or her attention from his or her driving. Because the mobile information device is constructed this way, the user's convenience can be improved.

### Embodiment 2

In above-mentioned Embodiment 1, the case in which the application 2 specifies a general screen layout and a screen layout used during a travel for the application execution environment 3 every time. In this Embodiment 2, an embodiment in which a mobile information device enables an application 2 to specify only a screen layout used during a travel by causing an application execution environment 3 to notify the application 2 that the vehicle is travelling.

While the application 2 carries out a process of specifying only a screen layout used during a travel according to the notification showing that the vehicle is travelling, the basic structure of the mobile information device in accordance with Embodiment 2 is the same as that in accordance with Embodiment 1. Therefore, refer to the structure of the vehicle-mounted information device 1 shown in FIG. 1 for the structure of the mobile information device in accordance with Embodiment 2.

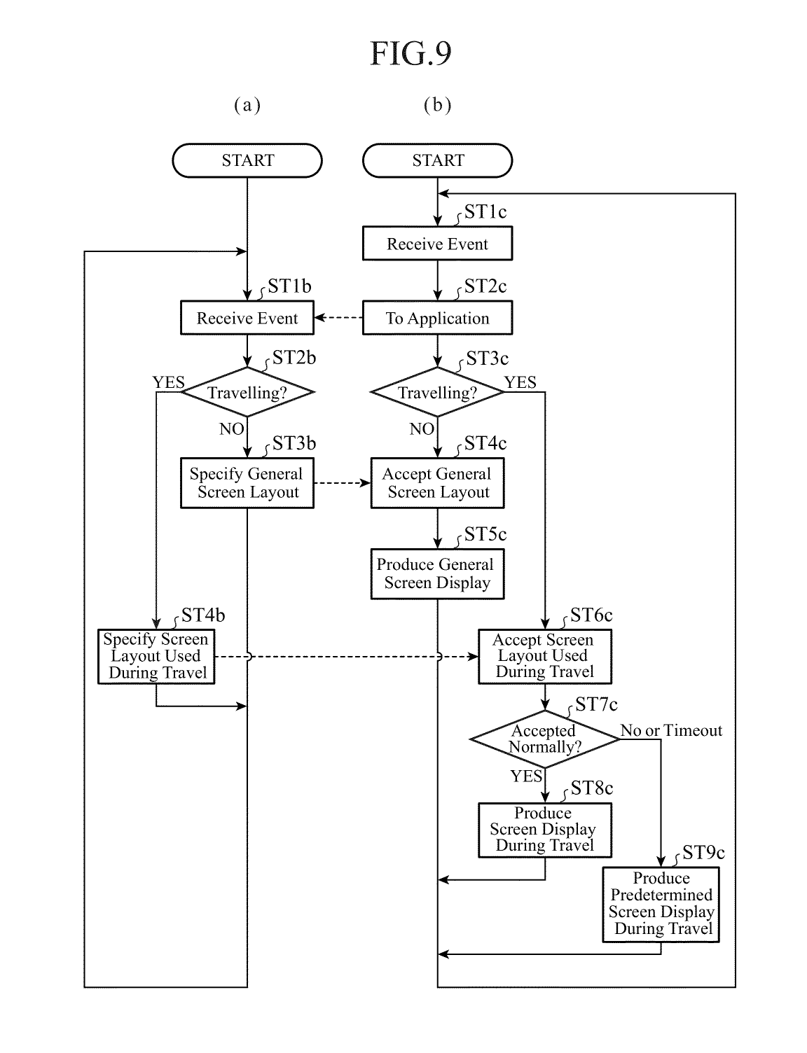

Next, the operation of the mobile information device will be explained. FIG. 9 is a flow chart showing the operation of the mobile information device in accordance with Embodiment 2 of the present invention, and shows the details of a screen display according to whether the vehicle is in a rest state or a travelling state. FIG. 9(a) shows a process resulting from the execution of the application 2, and FIG. 9 (b) shows a process in the application execution environment 3.

In the application execution environment 3, when receiving a travelling state change event from a travelling determining unit 4 or an operation event from an operation unit 6 (step ST1c), a controller 31 notifies the event received thereby to the application 2 via an event notification unit 34 (step ST2c). At this time, the controller 31 refers to the result of determination of whether or not the vehicle is travelling by the travelling determining unit 4, and includes data about the travelling state of the vehicle in the event to be notified. After that, when the vehicle is at rest (when NO in step ST3c), the controller 31 shifts to a process of step ST4c, and, when the vehicle is travelling (when YES in step ST3c), the controller shifts to a process of step ST6c.

When the event is notified thereto from the application execution environment 3 (step ST1b), the application 2 determines whether or not the vehicle is travelling on the basis of the data showing the travelling state of the vehicle included in the event (step ST2b). When the vehicle is at rest (when NO in step ST2b), the application 2 specifies a general screen layout corresponding to the received event (step ST3b). More specifically, the application 2 calls a general-UI API 32 to specify display elements constructing a general screen according to the descriptions of the event, and the contents to be displayed of the display elements, like that in accordance with above-mentioned Embodiment 1. The general-UI API 32 generates screen data about the general screen specified by the application 2, and sends the screen data to the controller 31 of the application execution environment 3.

The controller 31 accepts the general screen layout (step ST4c). More specifically, the controller 31 receives the screen data about the general screen from the general-UI API 32. After that, the controller 31 analyzes the screen data about the general screen, and carries out a drawing process of drawing the general screen according to a drawing command based on the result of this analysis. The display unit 5 receives drawing data generated by the controller 31 and displays the general screen (step ST5c).

In contrast, when the vehicle is travelling (when YES in step ST2b), the application 2 specifies a screen layout used during a travel corresponding to the received event (step ST4b). More specifically, the application 2 calls a UI-during-travel API 33 to specify display elements constructing a screen used during a travel according to the descriptions of the event, and the contents to be displayed of the display elements, like that according to above-mentioned Embodiment 1. The UI-during-travel API 33 generates screen data about the screen used during a travel on the basis of both template data defining a screen layout used during a travel and the descriptions specified by the application 2, and sends the screen data to the controller 31 of the application execution environment 3.

Next, the controller 31 accepts the screen layout used during a travel (step ST6c). More specifically, the controller 31 receives the screen data about the screen used during a travel from the UI-during-travel API 33. At this time, the controller 31 determines whether it has accepted the screen data normally from the UI-during-travel API 33 (step ST7c). In this embodiment, the controller carries out, as a criterion by which to determine whether it has accepted the screen data normally, a process of determining whether it has received the screen data in a state of being able to analyze the screen data or whether it has received the screen data within a predetermined acceptance time interval.

When determining that the screen data has been accepted normally (when YES in step ST7c), the controller 31 analyzes the screen data and carries out a drawing process of drawing the screen used during a travel according to a drawing command based on the result of this analysis. The display unit 5 receives drawing data generated by the controller 31 and displays the screen used during a travel (step ST8c). After that, the application execution environment 3 repeats the above-mentioned processes.

Further, when determining that the screen data has not been accepted normally because the screen data has not been received in a state of being able to analyze the screen data or the screen data has not been received within a predetermined acceptance time interval (when NO or a timeout occurs in step ST7c), the controller 31 analyzes data about a predetermined screen used during a travel which is prepared in advance in the application execution environment 3, and carries out a drawing process of drawing the screen used during a travel according to a drawing command based on the result of this analysis. The display unit 5 receives drawing data generated by the controller 31 and displays the predetermined screen used during a travel (step ST9c). After that, the application execution environment 3 repeats the above-mentioned processes. The data about the predetermined screen used during a travel is screen data showing a screen whose contents to be displayed are simplified regardless of the application 2 and the process corresponding to the event by taking into consideration the state in which the vehicle is travelling.

As mentioned above, in accordance with this Embodiment 2, the general-UI API 32 generates screen data about a general screen when the vehicle is at rest, and the UI-during-travel API 33 generates screen data about a screen used during a travel when the vehicle is travelling. The application 2 thus specifies either one of the general screen layout and the screen layout used during a travel according to whether the vehicle is at rest or travelling by using the general-UI API 32 and the UI-during-travel API 33. Therefore, the amount of information which is processed by the application 2 can be reduced. In this case, the mobile information device can make a screen transition which differs between at the time when the vehicle is at rest and at the time when the vehicle is travelling.

### Embodiment 3

In above-mentioned Embodiments 1 and 2, the case of generating screen data about at least one of a general screen and a screen used during a travel when producing a screen display on the display unit 5, and displaying a screen associated with the screen data about at least one of the screens is shown. In this Embodiment 3, an embodiment in which an offscreen buffer that stores drawing data generated by analyzing screen data is disposed, drawing data about a general screen and drawing data about a screen used during a travel are generated and drawn in the offscreen buffer, and the drawing data about each of the screens in the offscreen buffer is displayed according to the travelling state of the vehicle is described.

While a mobile information device in accordance with Embodiment 3 carries out a process of drawing both a general screen and a screen used during a travel in the offscreen buffer and producing a screen display, the basic structure of the mobile information device in accordance with Embodiment 3 is the same as that in accordance with above-mentioned Embodiment 1. Therefore, refer to the structure of the vehicle-mounted information device 1 shown in FIG. 1 for the structure of the mobile information device in accordance with Embodiment 3.

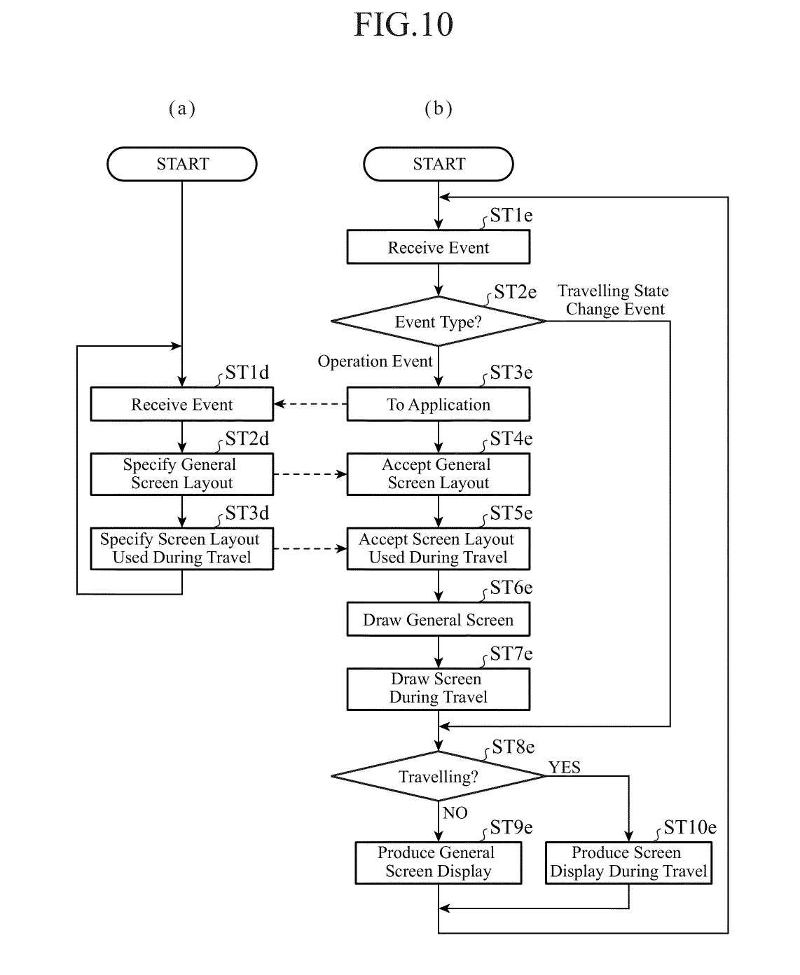

Next, the operation of the mobile information device will be explained. FIG. 10 is a flow chart showing the operation of the mobile information device in accordance with Embodiment 3 of the present invention, and shows the details of a screen display according to whether the vehicle is in a rest state or a travelling state. FIG. 10 (a) shows a process resulting from the execution of an application 2, and FIG. 10 (b) shows a process in an application execution environment 3.

In the application execution environment 3, when receiving an event (step ST1e), a controller 31 determines the type of the event received (step ST2e), like that in accordance with above-mentioned Embodiment 1. In this embodiment, it is assumed that the type of the event is a travelling state change event from a travelling determining unit 4 or an operation event from an operation unit 6.

When the type of the received event is a “travelling state change event” (when a travelling state change event occurs in step ST2e), the controller 31 shifts to a process of step ST8e. In contrast, when the type of the event is an “operation event” (when an operation event occurs in step ST2e), the controller 31 notifies the operation event to the application 2 currently being executed in the application execution environment 3 via an event notification unit 34 (step ST3e).

When the event is notified thereto from the application execution environment 3 (step ST1d), the application 2 specifies a general screen layout according to the received event (step ST2d). More specifically, the application 2 calls a general-UI API 32 to specify display elements constructing a general screen according to the descriptions of the event, and the contents to be displayed of the display elements, like that in accordance with above-mentioned Embodiment 1. The general-UI API 32 generates screen data about the general screen specified by the application 2 and sends the screen data to the controller 31 of the application execution environment 3.

The application 2 then specifies a screen layout used during a travel according to the event notified thereto from the application execution environment 3 (step ST3d). More specifically, the application 2 calls a UI-during-travel API 33 to specify display elements constructing a screen used during a travel according to the descriptions of the event, and the contents to be displayed of the display elements. The UI-during-travel API 33 generates screen data about the screen used during a travel on the basis of both template data defining a screen layout used during a travel and the descriptions specified by the application 2, and sends the screen data to the controller 31 of the application execution environment 3. When completing the process of step ST3d, the UI-during-travel API 33 returns to step ST1d and repeats the processes in steps ST1d to ST3d every time when receiving an event.

The controller 31 accepts the general screen layout (step ST4e) and then accepts the screen layout used during a travel (step ST5e). More specifically, the controller 31 receives the screen data about the general screen from the general-UI API 32, and then receives the screen data about the screen used during a travel from the UI-during-travel API 33. The controller 31 then analyzes the screen data about the general screen, generates drawing data about the general screen according to a drawing command based on the result of this analysis, and draws (stores) the drawing data in the offscreen buffer (step ST6e). The controller 31 further analyzes the screen data about the screen used during a travel, generates drawing data about the screen used during a travel according to a drawing command based on the result of this analysis, and draws (stores) the drawing data in the offscreen buffer with the drawing data being located in a display layer different from that in which the drawing data about the general screen is located (step ST7e).

After that, the controller 31 determines whether or not the vehicle is travelling (step ST8a). The controller carries out this determination by referring to the result of determination of whether or not the vehicle is travelling by the travelling determining unit 4, like that in accordance with above-mentioned Embodiment 1. When the vehicle is at rest (when NO in step ST8e), the controller 31 controls a display unit 5 so as to display the drawing data about the general screen drawn in the offscreen buffer. As a result, the display unit 5 displays the general screen drawn in the offscreen buffer (step ST9e). In contrast, when the vehicle is travelling (when YES in step ST8e), the controller 31 controls the display unit 5 so as to switch to and display the drawing data about the screen used during a travel which is drawn in the offscreen buffer. As a result, the display unit 5 displays the screen used during a travel drawn in the offscreen buffer (step ST10e).

As mentioned above, the mobile information device in accordance with this Embodiment 3 includes the off screen buffer that stores drawing data which the mobile information device generates by carrying out a drawing process of drawing screen data, and the controller 31 stores both drawing data acquired from screen data generated by the general-UI API 32 and drawing data acquired from screen data generated by the UI-during-travel API 33 in the offscreen buffer with the two drawing data being located in different display layers, switches between the two drawing data stored in the offscreen buffer according to whether or not the vehicle is travelling, and displays one of the two drawing data on the display unit 5. Because the mobile information device is constructed this way, when the state of the vehicle changes, the mobile information device can display either the general screen or the screen used during a travel by simply switching between the two drawing data stored in the offscreen buffer, and can change the screen display in a short time.

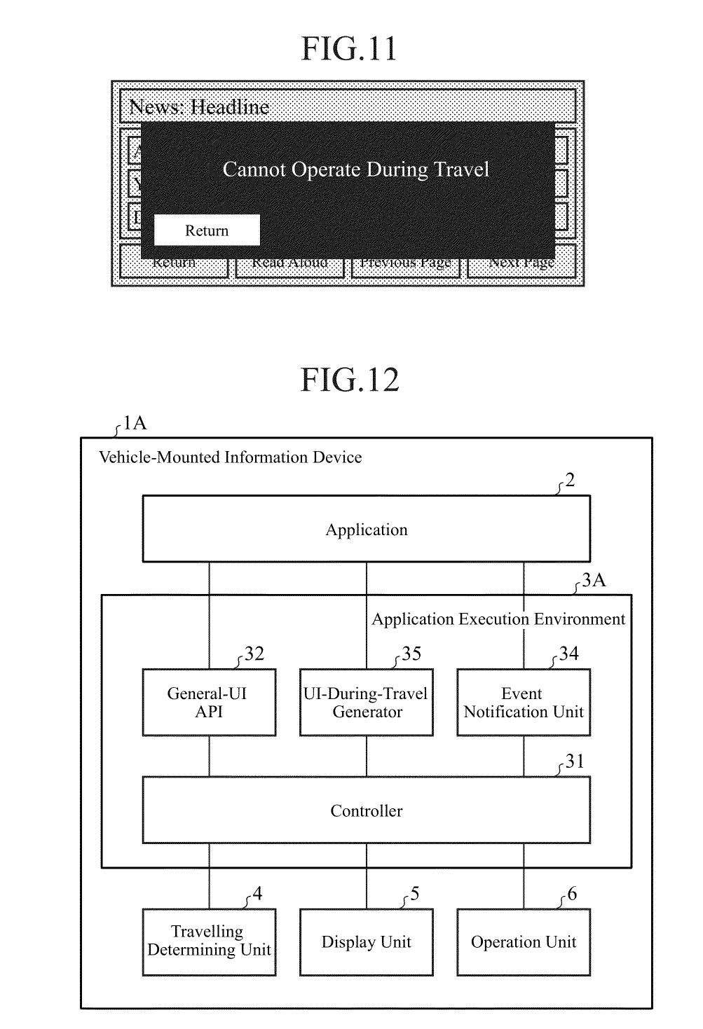

Although the case of switching between the general screen and the screen used during a travel and displaying one of them is shown in above-mentioned Embodiment 3, the layer of the screen used during a travel can be displayed overlappedly on the layer of the general screen, as shown in FIG. 11, when the vehicle is travelling. In this case, in order to improve the designability, the screens can be displayed in such a way that the upper layer screen is partially transparent or semi-transparent to a part of the lower layer screen.

### Embodiment 4

In above-mentioned Embodiments 1 to 3, the structure of including the general-UI API 32 which is used for the specification of a general screen layout, and the UI-during-travel API 33 which is used for the specification of a screen layout used during a travel is shown. In this Embodiment 4, an embodiment of including only a general-UI API 32 as an API used for the specification of a screen layout and generating screen data about a screen used during a travel from screen data about a general screen which is generated by the general-UI API 32 when the vehicle is travelling is described.

FIG. 12 is a block diagram showing the structure of a mobile information device in accordance with Embodiment 4 of the present invention, and shows a case in which the mobile information device in accordance with Embodiment 4 is applied to a vehicle-mounted information device. An application execution environment 3A in which an application 2 is executed, a travelling determining unit 4, a display unit 5, and an operation unit 6 are disposed in the vehicle-mounted information device 1A shown in FIG. 12. The application execution environment 3A is the one in which the application 2 is executed, and is provided with a controller 31, the general-UI API 32, an event notification unit 34, and a UI-during-travel generator 35. More specifically, the application execution environment 3A corresponds to the application execution environment 3 of the vehicle-mounted information device 1 shown in FIG. 1 in which the UI-during-travel generator 35 is disposed instead of the UI-during-travel API 33. The UI-during-travel generator 35 generates screen data about a screen used during a travel from screen data about a general screen generated by the general-UI API 32 according to predetermined rules. In FIG. 12, the same components as those shown in FIG. 1 are designated by the same reference numerals, and the explanation of the components will be omitted hereafter.

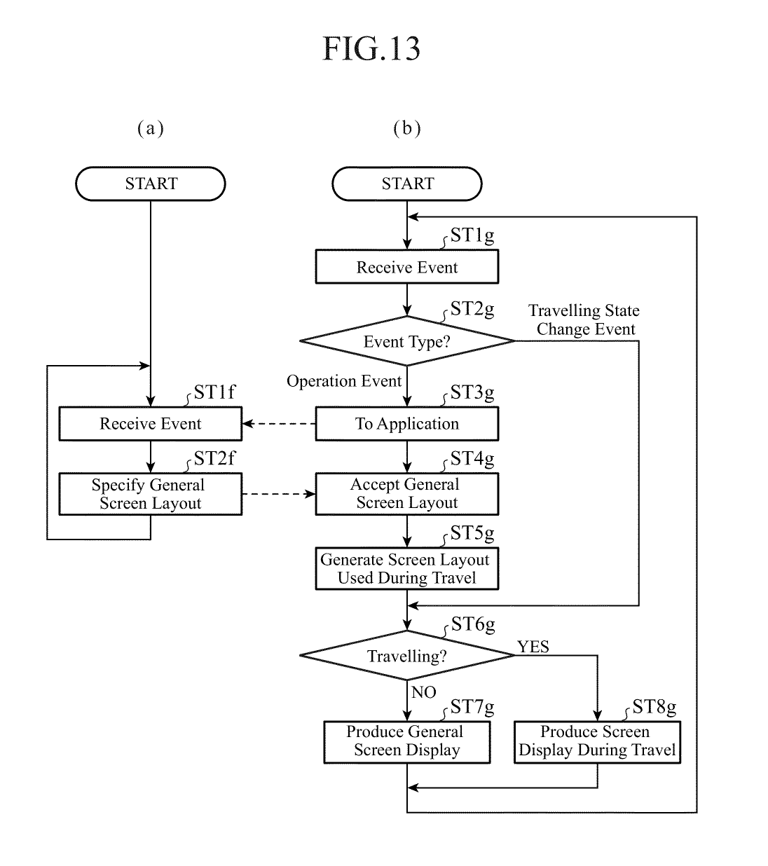

Next, the operation of the mobile information device will be explained. FIG. 13 is a flow chart showing the operation of the mobile information device in accordance with Embodiment 4, and shows the details of a screen display produced by the vehicle-mounted information device 1A according to whether the vehicle is at rest or travelling. FIG. 13(a) shows a process resulting from the execution of the application 2, and FIG. 13(b) shows a process in the application execution environment 3A. In the application execution environment 3A, when receiving an event (step ST1g), the controller 31 determines the type of the event received (step ST2g), like that in accordance with above-mentioned Embodiment 1. In this embodiment, it is assumed that the type of the event is a travelling state change event from the travelling determining unit 4 or an operation event from the operation unit 6.

When the type of the received event is a “travelling state change event” (when a travelling state change event occurs in step ST2g), the controller 31 shifts to a process of step ST6g. In contrast, when the type of the event is an “operation event” (when an operation event occurs in step ST2g), the controller 31 notifies the operation event to the application 2 currently being executed in the application execution environment 3A via the event notification unit 34 (step ST3g).

When the event is notified thereto from the application execution environment 3A (step ST1f), the application 2 specifies a general screen layout according to the above-mentioned event (step ST2f). More specifically, the application 2 calls the general-UI API 32 to specify display elements constructing a general screen according to the descriptions of the event, and the contents to be displayed of the display elements, like that in accordance with above-mentioned Embodiment 1. The general-UI API 32 generates screen data about the general screen specified by the application 2 and sends the screen data to the controller 31 of the application execution environment 3A. The controller 31 accepts the general screen layout (step ST4g). More specifically, the controller 31 receives the screen data about the general screen from the general-UI API 32.

Next, the UI-during-travel generator 35 receives the screen data about the general screen from the controller 31, and automatically generates screen data about a screen used during a travel from this screen data according to the predetermined rules (step ST5g). For example, the following rules (1) to (3) are provided.

(1) Select “template-A” as a template for the screen used during a travel.

(2) Extract the first character string in the screen data about the general screen, and replace the character string of a page header defined by “msg1” in the template for the screen used during a travel with the first character string.

(3) Extract two button elements from the head of the screen data about the general screen, and replace the character strings of buttons in the template for the screen used during a travel with the two button elements.

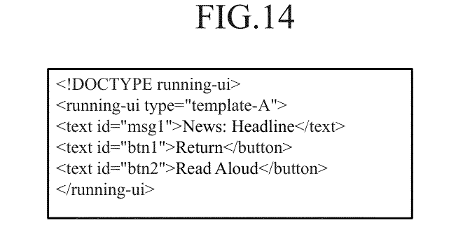

FIG. 14 shows the screen data about the screen used during a travel which is generated from the screen data about the general screen shown in FIG. 2 according to the above-mentioned rules (1) to (3). The UI-during-travel generator 35 selects “template-A” as the template for the screen used during a travel, as shown in FIG. 14. The UI-during-travel generator 35 then extracts “News: Headline” (refer to FIG. 2) which is the first character string in the screen data about the general screen, and replaces the character string described in the page header defined by “msg1” in the above-mentioned template with “News: Headline.” Next, the UI-during-travel generators 35 extracts “Return” and “Read aloud” which are the two button elements sequentially located in a line from the head of the screen data about the general screen, and replaces the character strings described in the buttons in the template for the screen used during a travel with “Return” and “Read Aloud.” As a result, the screen data about the screen used during a travel which is the same as that shown in FIG. 5 is generated.

The explanation is returned to FIG. 13. When receiving both the screen data about the general screen and the screen data about the screen used during a travel which is generated by the UI-during-travel generator 35, the controller 31 determines whether or not the vehicle is travelling (step ST6g). The controller carries out this determination by referring to the result of determination of whether or not the vehicle is travelling by the travelling determining unit 4. When the vehicle is at rest (when NO in step ST6g), the controller 31 analyzes the screen data about the general screen and carries out a drawing process of drawing the general screen according to a drawing command based on the result of this analysis. The display unit 5 receives drawing data generated by the controller 31, and displays the general screen (step ST7g).

In contrast, when the vehicle is travelling (when YES in step ST6g), the controller 31 analyzes the screen data about the screen used during a travel and carries out a drawing process of drawing the screen used during a travel according to a drawing command based on the result of this analysis. The display unit 5 receives drawing data generated by the controller 31, and displays the screen used during a travel (step ST8g). After that, the application execution environment 3A repeats the above-mentioned processes.

As mentioned above, because the mobile information device in accordance with this Embodiment 4 includes the UI-during-travel generator 35 that generates screen data about a screen used during a travel from screen data about a general screen, the mobile information device can also specify a screen layout used during a travel simultaneously only by enabling the application 2 to specify a general screen layout. Further, because when the general-UI API 32 generates screen data, the UI-during-travel generator 35 generates screen data about a screen layout used during a travel corresponding to the screen data, when the state of the vehicle (a rest or travelling state) changes, the mobile information device can promptly switch to a screen corresponding to the changed state of the vehicle.

Further, in above-mentioned Embodiment 4, the case in which the UI-during-travel generator 35, in step ST5g, generates screen data about a screen used during a travel from screen data about a general screen, and, when, in step ST6g, determining that the vehicle is travelling, the mobile information device displays the screen used during a travel on the display unit 5 by using drawing data based on the screen data about the screen used during a travel is shown. The present invention is not limited to the above-mentioned flow of the processing. As an alternative, the UI-during-travel generator 35 can prevent itself from generating screen data about a screen used during a travel from screen data about a general screen until the result of the determination of whether or not the vehicle is travelling is provided, and, only when the result of the above-mentioned determination shows that the vehicle is travelling, can generate screen data about a screen used during a travel from screen data about a general screen and display the screen used during a travel on the display unit 5 by using drawing data based on the screen data about the screen used during a travel.

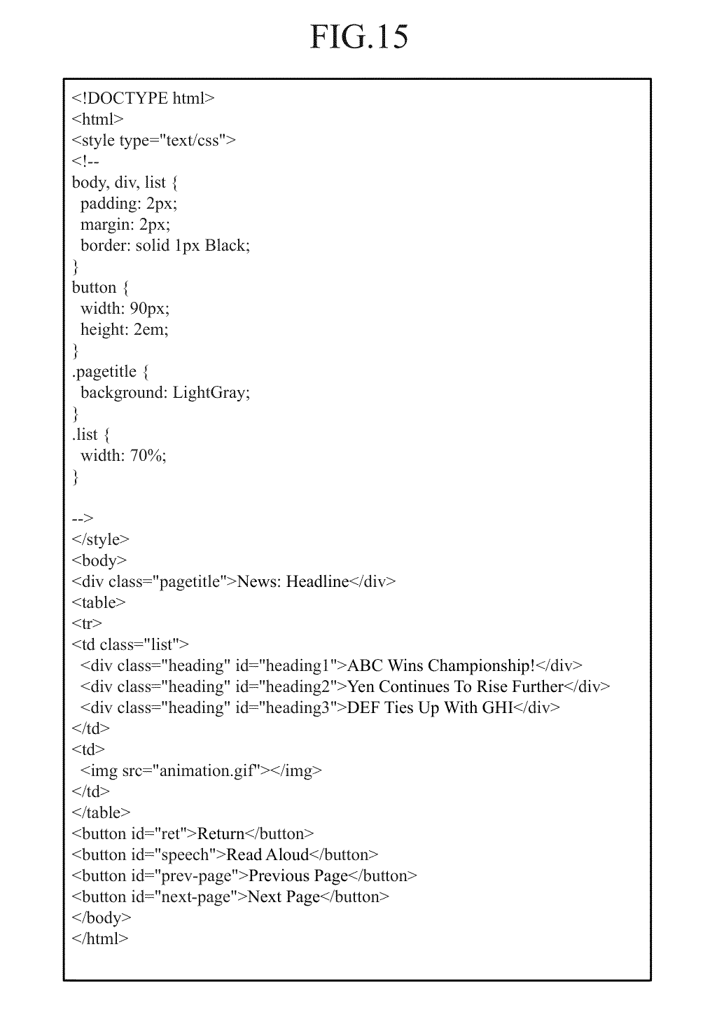

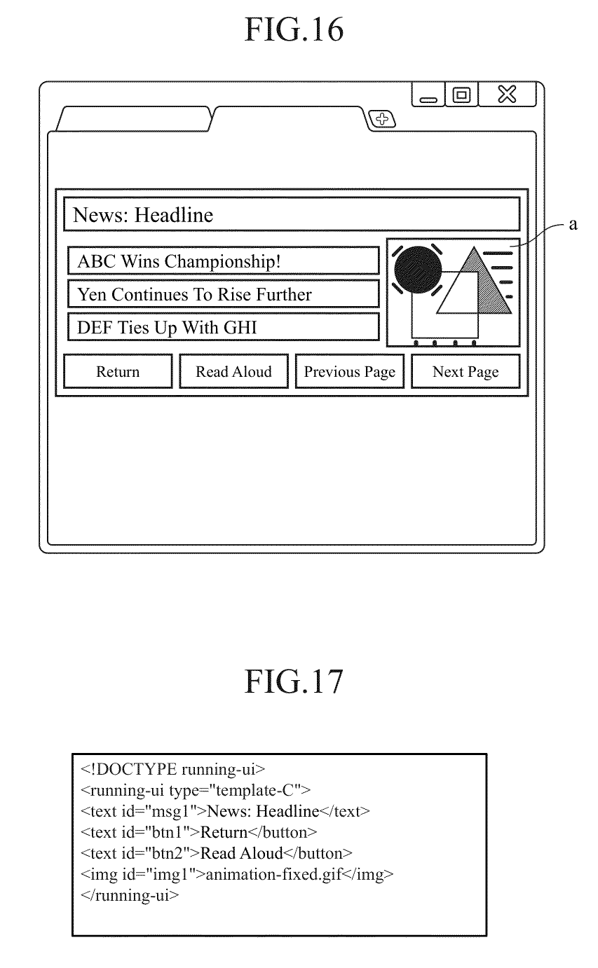

In addition, in above-mentioned Embodiment 4, it is desirable to, when displaying an image, an animation, a video, or the like on the display unit 5, convert such a moving image as an animation or a video into a still image and display this still image when the vehicle is travelling. FIG. 15 is a diagram showing an example of screen data in which a screen layout to be displayed when the vehicle is at rest is expressed in an HTML form, and shows screen data about a general screen including an animation image as a display element. Further, FIG. 16 is a diagram showing a screen displayed on the basis of the screen data shown in FIG. 15. In FIG. 15, the animation element is specified by an “img” element. Further, in the example shown in FIG. 16, the animation a specified by the “img” element is displayed on a right side of rectangles in which “ABC Wins Championship!”, “Yen Continues to Rise Further”, and “DEF Ties up with GHI” are described.

The UI-during-travel generator 35 generates screen data about a screen used during a travel from the screen data about the general screen shown in FIG. 15 according to the following rules (1A) to (4A).

(1A) Select “template-C” as a template for the screen used during a travel.

(2A) Extract the first character string in the screen data about the general screen, and replace the character string of a page header defined by “msg1” in the template for the screen used during a travel with the first character string.

(3A) Extract two button elements from the head of the screen data about the general screen, and replace the character strings of buttons in the template for the screen used during a travel with the two button elements.

(4A) Extract the first animation in the screen data about the general screen, and replace the “img” element with the still image into which this animation is converted.

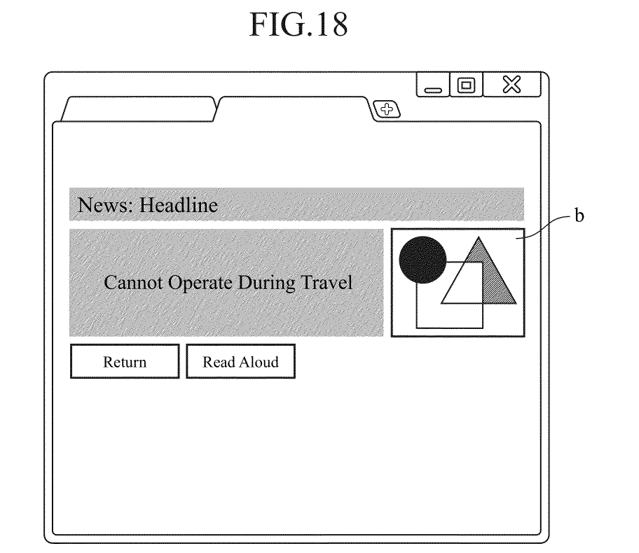

FIG. 17 shows the screen data about the screen used during a travel which the UI-during-travel generator 35 generates from the screen data shown in FIG. 15 according to the above-mentioned rules (1A) to (4A). Further, FIG. 18 is a diagram showing a screen displayed on the basis of the screen data shown in FIG. 17. “animation-fixed.gif” in FIG. 17 is the still image into which the animation shown by “animation.gif” in the screen data about the general screen shown in FIG. 15 is converted. The conversion of the animation into the still image is carried out by the UI-during-travel generator 35. For example, the UI-during-travel generator extracts a predetermined frame image (the first frame or the like) from the animation, and defines this frame image as the still image.

The screen used during a travel shown in FIG. 18 is displayed on the display unit 5 by using the drawing data generated on the basis of the screen data shown in FIG. 17. As shown in FIG. 18, the still image b into which the animation a is converted is described in the area on the screen shown in FIG. 16 where the animation a is described. As mentioned above, when generating screen data about a screen used during a travel from screen data about a general screen, the mobile information device can display a screen suitable for display when the vehicle is travelling by converting an animation or a moving image into a still image.

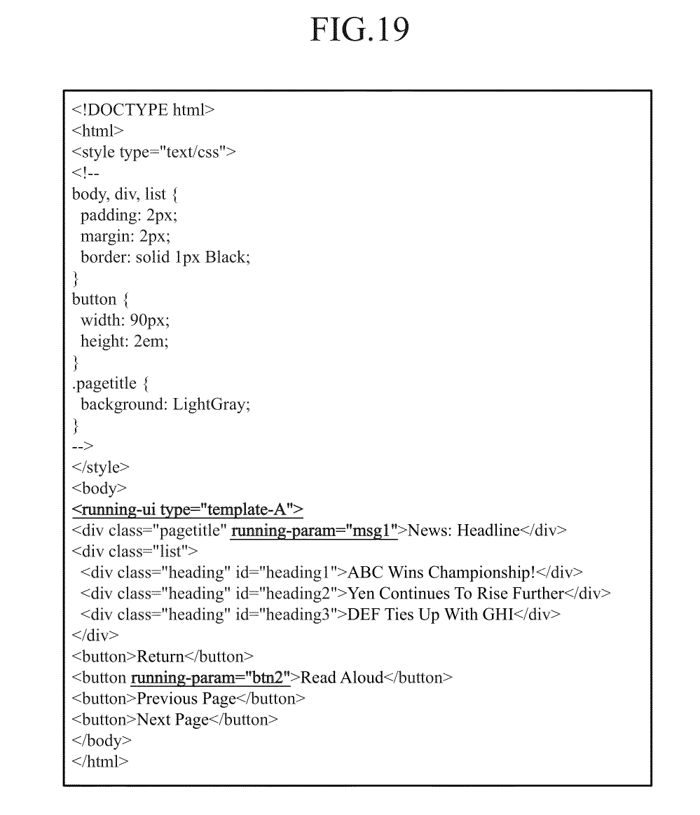

In addition, in above-mentioned Embodiment 4, the general-UI API 32 can include information constructing a screen used during a travel into the screen data about a general screen as additional information, and the UI-during-travel generator 35 can generate screen data about a screen used during a travel from this additional information. FIG. 19 is a diagram showing the screen data about a general screen including the information constructing a screen used during a travel. The screen data shown in FIG. 19 includes a “running-ui type” element and a “running-param” attribute in addition to the screen data shown in FIG. 2 explained in Embodiment 1. In this case, the “running-ui type” element shows template data for use in the screen data about a screen used during a travel generated from the screen data shown in FIG. 19. Further, the “running-param” attribute shows that the character string is described by a “text” element in the screen data about the screen used during a travel generated from the above-mentioned screen data about the general screen. The UI-during-travel generator 35 can generate screen data about a screen used during a travel by combining the “running-ui type” element which is the information constructing the screen used during a travel included in the screen data shown in FIG. 19, and the descriptions of the “running-param” attribute. From the screen data shown in FIG. 19, screen data which is the same as screen data about a screen used during a travel shown in FIG. 4 is generated.

In addition, in above-mentioned Embodiment 4, an offscreen buffer that stores drawing data acquired by carrying out a drawing process of drawing screen data can be disposed, and the controller 31 can store both drawing data acquired from screen data generated by the general-UI API 32 and drawing data acquired from screen data generated by the UI-during-travel API 33 in the offscreen buffer with the two drawing data being located in different display layers, switch between the two drawing data stored in the offscreen buffer according to whether or not the vehicle is travelling, and display one of the two drawing data on the display unit 5. Even in the case in which the mobile information device is constructed this way, when the state of the vehicle changes, the mobile information device can display either the general screen or the screen used during a travel by simply switching between the two drawing data stored in the offscreen buffer, and can change the screen display in a short time, like that according to above-mentioned Embodiment 4.

### Embodiment 5

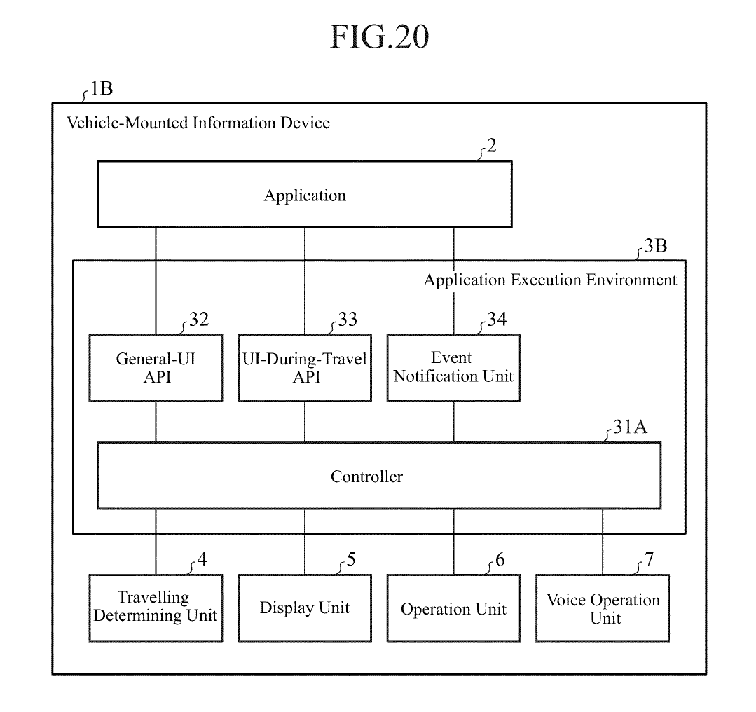

FIG. 20 is a block diagram showing the structure of a mobile information device in accordance with Embodiment 5 of the present invention, and shows a case in which the mobile information device in accordance with Embodiment 5 is applied to a vehicle-mounted information device. In the vehicle-mounted information device 1B shown in FIG. 20, an application execution environment 3B in which an application 2 is executed, a travelling determining unit 4, a display unit 5, an operation unit 6, and a voice operation unit 7 are disposed. Further, the application execution environment 3B is the one in which the application 2 is executed, and is provided with a controller 31A, a general-UI API 32, a UI-during-travel API 33, and an event notification unit 34.

The voice operation unit 7 recognizes a voice uttered by a user, and notifies the result of the recognition to the controller 31A of the application execution environment 3B as a voice event. In this embodiment, command character strings are registered from the controller 31A into the voice operation unit 7, and, when a voice matching or resembling one of these command strings is uttered, it is determined that a voice event has occurred. In FIG. 20, the same components as those shown in FIG. 1 are designated by the same reference numerals, and the explanation of the components will be omitted hereafter.

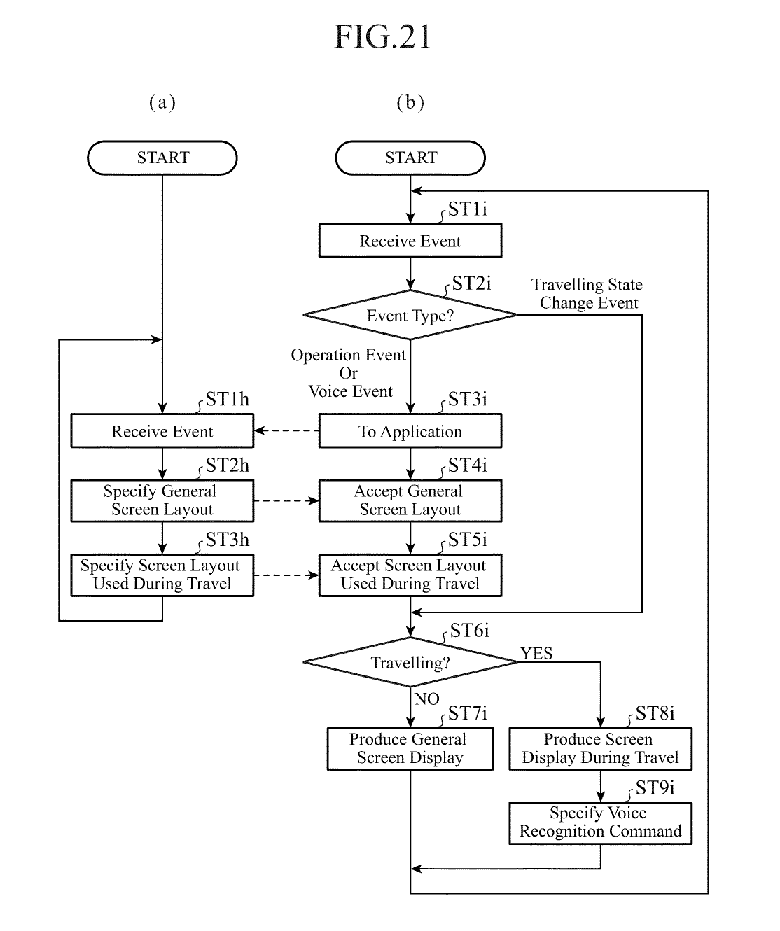

Next, the operation of the mobile information device will be explained. FIG. 21 is a flow chart showing the operation of the mobile information device in accordance with Embodiment 5, and shows the details of a screen display which the vehicle-mounted information device 1B produces according to whether the vehicle is at rest or travelling. FIG. 21 (a) shows a process resulting from the execution of the application 2, and FIG. 21(b) shows a process in the application execution environment 3B. In the application execution environment 3B, when receiving an event (step ST1i), the controller 31A determines the type of the event received (step ST2i). In this embodiment, it is assumed that the type of the event is a travelling state change event from the travelling determining unit 4, an operation event from the operation unit 6, or a voice event from the voice operation unit 7.

When the type of the received event is a “travelling state change event” (when a travelling state change event occurs in step ST2i), the controller 31A shifts to a process of step ST6i. In contrast, when the type of the event is an “operation event” or a “voice event” (when an operation event or a voice event occurs in step ST2i), the controller 31A notifies the above-mentioned event to the application 2 currently being executed in the application execution environment 3B via the event notification unit 34 (step ST3i).

When the event is notified thereto from the application execution environment 3B (step ST1h), the application 2 specifies a general screen layout according to the above-mentioned event (step ST2h). More specifically, the application 2 calls the general-UI API 32 to specify display elements constructing a general screen according to the descriptions of the event, and the contents to be displayed of the display elements, like that in accordance with above-mentioned Embodiment 1. The general-UI API 32 generates screen data about the general screen specified by the application 2 and sends the screen data to the controller 31A of the application execution environment 3B.

The application 2 then specifies a screen layout used during a travel corresponding to the event notified thereto from the application execution environment 3B (step ST3h). More specifically, the application 2 calls the UI-during-travel API 33 to specify display elements constructing a screen layout used during a travel according to the descriptions of the event, and the contents to be displayed of the display elements. The UI-during-travel API 33 generates screen data about the screen used during a travel on the basis of both template data defining a screen layout used during a travel and the descriptions specified by the application 2, and sends the screen data to the controller 31A of the application execution environment 3B.

Because a voice operation is the one which does not have to be performed manually and which is suitable for display when the vehicle is travelling, the UI-during-travel API 33 in accordance with this Embodiment 5 incorporates voice commands of operations regarding the descriptions of the received event into the screen data about the screen used during a travel. When completing the process of step ST3h, the UI-during-travel API 33 returns to step ST1h and repeats the processes in steps ST1h to ST3h every time when receiving an event.

The controller 31A accepts the general screen layout (step ST4i), and then accepts the screen layout used during a travel (step ST5i). More specifically, the controller 31A receives the screen data about the general screen from the general-UI API 32, and then receives the screen data about the screen used during a travel from the UI-during-travel API 33. After that, the controller 31A determines whether or not the vehicle is travelling (step ST6i). The controller carries out this determination by referring to the result of determination of whether or not the vehicle is travelling by the travelling determining unit 4.

When the vehicle is at rest (when NO in step ST6i), the controller 31A analyzes the screen data about the general screen and carries out a drawing process of drawing the general screen according to a drawing command based on the result of this analysis. The display unit 5 receives drawing data generated by the controller 31A, and displays the general screen (step ST7i). After that, the application execution environment 3B repeats the above-mentioned processes.

In contrast, when the vehicle is travelling (when YES in step ST6i), the controller 31A analyzes the screen data about the screen used during a travel and carries out a drawing process of drawing the screen used during a travel according to a drawing command based on the result of this analysis. The display unit 5 receives drawing data generated by the controller 31A, and displays the screen used during a travel (step ST8i). Next, the controller 31A registers the voice commands included in the screen data about the screen used during a travel into the voice operation unit 7 (step ST9i).

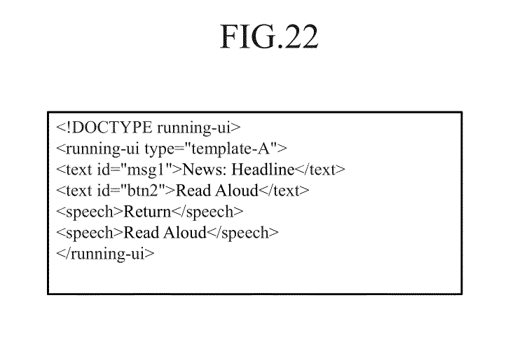

FIG. 22 is a diagram showing the screen data about the screen used during a travel into which the voice commands are incorporated. The screen data shown in FIG. 22 is the one in which two “speech” elements showing the voice commands are added to the screen data shown in FIG. 4. The controller 31A, in step ST9i, registers the voice commands “Return” and “Read Aloud” which are respectively described in the “speech” elements into the voice operation unit 7. The screen used during a travel displayed on the basis of the screen data shown in FIG. 22 is the same as that shown in FIG. 5.

When a voice matching or resembling one of the above-mentioned voice commands is uttered while the above-mentioned screen used during a travel is displayed on the display unit 5, the voice operation unit 7 notifies a voice event to the controller 31A of the application execution environment 3B. When receiving the voice event from the voice operation unit 7, the controller 31A notifies the voice event to the application 2 via the step ST event notification unit 34.

As mentioned above, because the mobile information device in accordance with this Embodiment 5 includes the voice operation unit 7 that recognizes a voice uttered by a user, and, when the result of the recognition matches or resembles a voice command registered in the controller 31A, notifies the result of the recognition to the controller 31A as a voice event, and the UI-during-travel API 33 generates screen data about a screen layout used during a travel into which voice commands are incorporated, the mobile information device enables the user to perform an operation on a screen used during a travel through voice recognition.

Although the case in which the voice operation unit 7 is added to the structural components in accordance with either one of above-mentioned Embodiments 1 to 3 is shown in above-mentioned Embodiment 5, the voice operation unit 7 can be alternatively added to the structural components in accordance with above-mentioned Embodiment 4. In this case, when generating screen data about a screen used during a travel from screen data about a general screen, the UI-during-travel generator 35 incorporates voice commands into the screen data about the screen used during a travel. Also in the case in which the mobile information device is constructed this way, the same advantages as those mentioned above can be provided.

Further, although an API which specifies a screen layout in an HTML or XML form is shown in above-mentioned Embodiments 1 to 5, a screen layout can be alternatively specified by using another language or another method. For example, an API using classes and methods written in the Java (registered trademark) language can be used.

In addition, although the case of displaying a screen used during a travel on the display unit 5 when the vehicle is travelling is shown in above-mentioned Embodiments 1 to 5, display units other than a display unit recognized visually and mainly by the driver, among a plurality of display units mounted for the front seat and rear seats of the vehicle, can be made to display a general screen without switching to a screen used during a travel even when the vehicle is travelling. For example, the controller 31 specifies the display unit 5 recognized visually and mainly by the driver on the basis of the identification information for identifying each of the plurality of display units, controls the display unit 5 so as to switch between the general screen and the screen used during a travel according to whether or not the vehicle is travelling, and controls the display units other than the above-mentioned display unit 5 so as not to switch to the screen used during a travel, but to display the general screen even when the vehicle is travelling.

Although the case of applying the mobile information device in accordance with the present invention to a vehicle-mounted information device is shown in above-mentioned Embodiments 1 to 5, the mobile information device in accordance with the present invention can be mounted in a rail car, a ship, or an airplane, instead of a vehicle, or can be a mobile information terminal which a person carries onto a vehicle and uses, e.g., a PND (Portable Navigation Device).

While the present invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the mobile information device in accordance with the present invention can display a screen suitable display when a moving object is at rest and a screen suitable display when the moving object is travelling, the mobile information device is suitable for use in a vehicle-mounted information device, such as a car navigation device, in which limitations are imposed on operations when a vehicle is travelling.

### EXPLANATIONS OF REFERENCE NUMERALS

1, 1A, and 1B vehicle-mounted information device, 2 application, 3, 3A, and 3B application execution environment, 4 travelling determining unit, 5 display unit, 6 operation unit, 7 voice operation unit, 31 and 31A controller, 32 general-UI API, 33 UI-during-travel API, 34 event notification unit, 35 UI-during-travel generator.

1. A mobile information device including a display that produces a screen display and an application execution environment in which an application is executed, said mobile information device comprising:
a first API (Application Program Interface) that generates screen data about a screen layout specified by said application;
a second API that generates screen data about a screen layout specified by said application and used during travel on a basis of template data defining said screen layout used during travel which is to be displayed when a moving object is travelling; and
a controller that is disposed in said application execution environment, and that causes said display to display said screen data generated by said first API when said moving object is at rest and causes said display to display said screen data generated by said second API when said moving object is travelling.

2. The mobile information device according to claim 1, wherein said application execution environment has a plurality of template data defining a plurality of screen layouts to be displayed when said moving object is travelling respectively, and said second API generates the screen data about the screen layout used when said moving object is travelling on a basis of template data which said second API selects from among said plurality of template data according to a specification made by said application.

3. The mobile information device according to claim 1, wherein said second API changes display elements constructing the screen layout defined by said template data according to a command from said application, and generates the screen data about said screen layout used during travel.

4. The mobile information device according to claim 1, wherein said second API changes an aspect of each of display elements constructing said screen used during travel which is generated on a basis of said template data within a predetermined limit according to a command from said application.

5. The mobile information device according to claim 1, wherein said first API generates said screen data when said moving object is rest, and said second API generates the screen data about said screen layout used during travel when said moving object is travelling.

6. The mobile information device according to claim 1, wherein said mobile information device includes an offscreen buffer that stores drawing data acquired by carrying out a drawing process of drawing said screen data, and said controller stores drawing data acquired from the screen data generated by said first API and drawing data acquired from the screen data generated by said second API in said offscreen buffer with the two drawing data being located in different display layers, and switches between said two drawing data stored in said offscreen buffer according to whether or not said moving object is travelling and causes said display to display said drawing data.

7. The mobile information device according to claim 1, wherein said mobile information device includes a voice operation unit that recognizes a voice uttered by a user, and, when a result of the recognition matches or resembles a voice command registered from said controller, notifies said recognition result to said controller as a voice event, and wherein said second API generates the screen data about the screen layout used during a travel into which said voice command is incorporated.

8. A mobile information device including a display that produces a screen display and an application execution environment in which an application is executed, said mobile information device comprising:
a first API (Application Program Interface) that generates screen data about a screen layout specified by said application;
a UI-during-travel generator that generates screen data about a screen layout displayed when said moving object is travelling and used during a travel, said screen layout being specified by said application, on a basis of the screen data generated by said first API; and
a controller that is disposed in said application execution environment, and that causes said display to display said screen data generated by said first API when said moving object is at rest and causes said display to display said screen data generated by said UI-during-travel generator when said moving object is travelling.

9. The mobile information device according to claim 8, wherein when a moving image is included in the screen produced from the screen data generated by said first API, said UI-during-travel generator generates the screen data about the screen layout in which said moving image is converted into a still image.

10. The mobile information device according to claim 8, wherein said first API generates the screen data including information constructing the screen data about said screen layout used during a travel as additional information, and said UI-during-travel generator generates the screen data about said screen layout used during a travel on a basis of said additional information in the screen data generated by said first API.

11. The mobile information device according to claim 8, wherein said mobile information device includes an offscreen buffer that stores drawing data acquired by carrying out a drawing process of drawing said screen data, and said controller stores drawing data acquired from the screen data generated by said first API and drawing data acquired from the screen data generated by said UI-during-travel generator in said offscreen buffer with the two drawing data being located in different display layers, and switches between said two drawing data stored in said offscreen buffer according to whether or not said moving object is travelling and causes said display to display said drawing data.

12. The mobile information device according to claim 8, wherein said mobile information device includes a voice operation unit that recognizes a voice uttered by a user, and, when a result of the recognition matches or resembles a voice command registered from said controller, notifies said recognition result to said controller as a voice event, and wherein said UI-during-travel generator generates the screen data about the screen layout used during a travel into which said voice command is incorporated.

13. The mobile information device according to claim 1, wherein said mobile information device includes a plurality of displays, and said controller causes a predetermined one of said plurality of displays to display said screen data generated by said first API when said moving object is at rest and causes said predetermined display to display the screen data about said screen layout used during a travel while said moving object is travelling, and causes displays of said plurality of displays, other than said predetermined display, to display said screen data generated by said first API regardless of whether or not said moving object is travelling.

14. The mobile information device according to claim 8, wherein said mobile information device includes a plurality of displays, and said controller causes a predetermined one of said plurality of displays to display said screen data generated by said first API when said moving object is at rest and causes said predetermined display to display the screen data about said screen layout used during a travel while said moving object is travelling, and causes displays of said plurality of displays, other than said predetermined display, to display said screen data generated by said first API regardless of whether or not said moving object is travelling.
